(19) United States
(12) Patent Application Publication
(10) Pub. No.: US 2005/0169150 A1
(43) Pub. Date: Aug. 4, 2005

(54) Method to display visual information

(76) Inventor: Jonathan Resnick, New York, NY (US)

Correspondence Address: LAW OFFICE OF DALE F. REGELMAN, P.C., 4231 S. Fremont Avenue, Tucson, AZ, 85714, US

(21) Appl. No.: 11/036,561

(22) Filed: Jan. 14, 2005

Related U.S. Application Data
(60) Provisional application No. 60/536,390, filed on Jan. 14, 2004.

(51) Int. Cl. G11B 5/09

(52) U.S. Cl. 369/59.23

(57) ABSTRACT

A method is disclosed to display visual information. The method supplies an optical disk comprising encoded information, an optical disk drive assembly capable of reading that encoded information, and a visual display device interconnected with the optical disk drive assembly. The method removeably inserts the optical disk into the optical disk drive assembly, reads the encoded information by the optical disk drive assembly from the optical disk, and generates a signal by the optical disk drive assembly using the encoded information, where that signal comprises first visual information and second visual information. The method then provides the signal to the visual display device, displays the first visual information, where the first visual information comprises an entertainment event, and continuously displays the second visual information, where that second visual information comprises a jump forward icon.

### CROSS REFERENCE TO RELATED APPLICATIONS

This Application claims priority from a Provisional Application having Ser. No. 60/536,390.

### FIELD OF THE INVENTION

The invention relates to a method to display visual information.

### BACKGROUND OF THE INVENTION

It is known in the art to encode information comprising entertainment events, such as movies, concerts, and the like, in one or several optical disk formats. Such optical disk formats include DVD, once-writable DVDs, rewritable DVDs, and the like. Prior art methods utilize optical disks comprising known formats in combination with optical disk drive assemblies and visual display devices to display such entertainment events.

Prior art methods read the encoded information sequentially, generate a signal comprising visual information from the encoded information, and provide that signal to the visual display device. Alternatively, a user may manually cause the optical disk drive assembly to read the encoded information non-sequentially, i.e. repeat certain portions and/or skip certain portions. Using prior art methods, such non-sequential reading requires the user to generate a plurality of inputs to the optical disk drive assembly, such as for example depressing a fast-forward button on a remote control device until a desired portion of the entertainment event is observed. Frequently, the user “overshoots” the beginning of the desired portion, and must then selectively operate a reverse button on the remote unit.

What is needed is a method to easily transition from sequentially reading the encoded information to immediately reading encoded information from a pre-determined target location on the optical medium by activating a continuously displayed jump ahead icon.

### SUMMARY OF THE INVENTION

Applicant's invention includes a method to display visual information. Applicant's method supplies an optical disk comprising encoded information, an optical disk drive assembly capable of reading that encoded information, and a visual display device interconnected with the optical disk drive assembly.

The method removeably inserts the optical disk into the optical disk drive assembly, reads the encoded information by the optical disk drive assembly from the optical disk, and generates a signal by the optical disk drive assembly using the encoded information, where that signal comprises first visual information and second visual information. The method then provides the signal to the visual display device, displays the first visual information, where the first visual information comprises an entertainment event, and continuously displays the second visual information, where that second visual information comprises a jump forward icon.

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram showing locations of one or more jump ahead icons;

FIG. 2 is a flow chart summarizing certain steps of Applicant's method; and

FIG. 3 is a flow chart summarizing certain optional steps of Applicant's method.

### DETAILED DESCRIPTION OF THE PREFERRED EMBODIMENTS

This invention is described in preferred embodiments in the following description with reference to the Figures, in which like numbers represent the same or similar elements. An optical disk system is presented which includes disk-specific information, and optionally user-specific settings. The optical disk system includes an apparatus and method to retrieve information and encoded video data stored upon an optical disk. In certain embodiments, the invention includes an input device for inputting user settings, and a microprocessor memory unit having a non-volatile portion for storing the disk information, and optionally, the user settings.

Information specific to the optical disks, i.e. a DVD, is stored within the non-volatile portion of the microprocessor memory unit. The optional user settings may include, for example, spoken language, video display format, audio volume setting, and subtitle language. The user settings may be retrieved and invoked, conveniently allowing a user to view a presentation (e.g., a movie), or to continue viewing an interrupted presentation, without having to reselect viewing and listening preferences.

The identification data may include a portion of a title of the optical disk. A value corresponding to the identification data (e.g., a checksum) may be stored in order to minimize storage requirements. The non-volatile portion of the microprocessor memory unit may include, for example, flash memory or electrically erasable programmable random access memory (EEPROM) which maintains stored contents even in the absence of applied electrical power. A sleep timer function may be activated which requires periodic user input to continue playback and to save a current playback location.

Optical disks are recording media typically containing long strings of microscopic pits representing digitally encoded data. Each string of pits is called a “track”. The tracks are formed end to end in a spiral pattern around the center of one or both major surfaces of the disk. Reflected laser light is used to “read” the data encoded in the pits. Common types of optical disks available today include compact disks (CDs), laser video disks, and digital versatile disks (DVDs). Various optical disk players are available which read data from optical disks.

The current DVD standard is a compromise format agreed upon by several major consumer electronic and entertainment companies. Under the current DVD standard, the capacity of a single side, single layer DVD with a diameter of 4.7 inches is 4.7 gigabytes, enough to store about 135 minutes of video data. This capacity is sufficient for about 95% of all full length movies. The current DVD standard also provides for up to eight different sound tracks in different languages, each with up to eight different audio channels to create a three-dimensional acoustic effect. In addition, up to 32 different sets of subtitles (i.e., translation text) may be stored on a DVD for display during playback.

By virtue of the numerous capabilities afforded by the DVD standard, a typical DVD player allows a user to select among a wide variety of viewing and listening options. The user typically makes these selections by navigating through several layers of menus displayed upon a television (TV) screen. For example, viewing options include display format, camera angle, and subtitles. A standard TV has a width-to-height (i.e., aspect) ratio of 4:3, while a widescreen TV has an aspect ratio of 16:9. Video data can be stored on a DVD for standard TV (4:3 display data) or widescreen TV (16:9 display data). DVD player display format options include full frame (4:3 format from 4:3 display data), letterbox (4:3 format from 16:9 display data), pan & scan (4:3 format from 16:9 display data), and widescreen (16:9 format from 16:9 display data). In letterbox format, a wide black stripe is added across the tops and bottoms of the 16:9 display data images such that proper proportions are maintained when the images are displayed upon a 4:3 screen. In pan and scan format, only 4:3 portions of the 16:9 display data images are displayed. Images “shot” from several different camera angles may be recorded on the disk, and the user may select any one of these camera angles for viewing. Subtitles in any one of up to 32 different languages may be superimposed upon portions of the images.

Audio options include language, number of channels, dynamic range, and volume. The user may select one of up to 8 different languages for playback. The user may also select desired values for number of audio channels, dynamic range, and volume. As described above, each of the up to 8 sound tracks in different languages may have up to 8 audio channels. Audio data encoded using Dolby® AC-3.™ may have 1 to 5.1 channels. Audio data encoded using MPEG-2 audio may have 1 to 5.1 or 7.1 channels. Audio data encoded using pulse code modulation (PCM) may have 1 to 8 channels. A user may select from the various audio options present on a disk.

As noted above, a user typically makes various selections by navigating through several layers of menus displayed upon a television (TV) screen. Generally, the user needs to first activate a control unit which then provides a signal to the DVD playback unit. Upon receiving that signal, the DVD playback unit then displays a menu on the screen.

As those skilled in the art will appreciate, the control unit may be hard-wired to the DVD player apparatus. In other embodiments, the control unit communicates with the DVD player apparatus using wireless communication methods. In certain embodiments, such wireless communication methods include using infrared frequencies. In certain embodiments, such wireless communication methods include using radio frequencies.

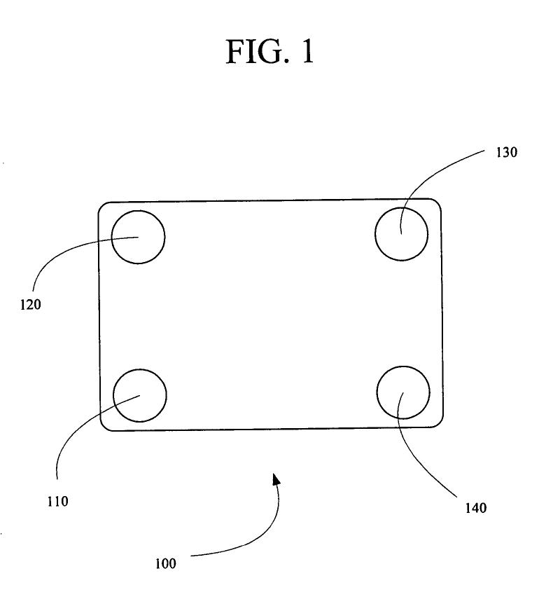

Using Applicants' method a visually-observable “jump forward” design, i.e. a jump forward icon, is continuously displayed on the screen while the DVD presentation is running. A viewer need not take any action to display this jump forward icon. Referring now to FIG. 1, screen display 100 comprises the observable DVD presentation. Screen display 100 includes one or more icons 110, 120, 130, and/or 140.

Screen display 100 comprises (N) square inches of area. In certain embodiments, icon 110 is displayed using about (N)/10 square inches of area. In certain embodiments, icon 120 is displayed using about (N)/10 square inches of area. In certain embodiments, icon 130 is displayed using about (N)/10 square inches of area. In certain embodiments, icon 140 is displayed using about (N)/10 square inches of area.

Activating the jump ahead icon causes the DVD presentation to immediately transition to a pre-determined target location of the program, and display a target portion of the entertainment event. In certain embodiments, the jump ahead icon is activated using the control device, i.e. by clicking on that jump ahead icon. As those skilled in the art will appreciate, an optical disk drive assembly comprises a read head, where that read head reads information encoded in the optical disk. Such a read head typically reads that encoded information sequentially along the tracks disposed on the optical disk.

Using Applicant's method, as the read head is sequentially reading the encoded information, and the jump ahead icon is activated, the method repositions the read head to a pre-determined target location on the optical disk wherein the target encoded information is located.

The target location may be disposed anywhere in the DVD presentation. In certain embodiments, the target location comprises the end portion of the DVD presentation. In certain embodiments, the target location comprises an introductory portion of the DVD presentation. In certain embodiments, the target location comprises a portion of the DVD presentation disposed anywhere between the introductory portion and the end portion.

In certain embodiments, the target location is determined by the DVD manufacturer. In certain embodiments, the target location is set by the user via an input device interconnected to the DVD player apparatus.

In certain embodiments, the DVD presentation comprises what is sometimes referred to as an “adult” video. As those skilled in the art will appreciate, such an adult video includes sexually explicit scenes. Certain of those sexually explicit scenes include what is commonly referred to as “foreplay.” Certain of those sexually explicit scenes may include, for example, sexual intercourse. Certain of those sexually explicit scenes may include, for example, masturbation.

In certain embodiments wherein the DVD presentation comprises a adult video, clicking the jump ahead icon causes the DVD player apparatus to transition to a sexual intercourse scene. In certain embodiments wherein the DVD presentation comprises a adult video, clicking the jump ahead icon causes the DVD player apparatus to transition to a masturbation scene.

In certain embodiments, the continuously displayed icon, such as for example icon 110, and/or icon 120. and/or icon 130, and/or icon 140, comprises a sexual organ. For example, in certain embodiments, icon 110, and/or icon 120, and/or icon 130, and/or icon 140, comprises a penis. In certain embodiments, icon 110, and/or icon 120, and/or icon 130, and/or icon 140, comprises a male and female engaging in sexual intercourse. In certain embodiments, the male component of the icon and female component of the icon comprise humans. In certain embodiments, the male component and/or female component comprise other animals.

In certain embodiments, the displayed icon may itself be animated. In certain embodiments, icon 110, and/or icon 120. and/or icon 130, and/or icon 140, comprises a penis, wherein clicking on that icon causes the penis icon to ejaculate as the DVD presentation is transitioning to the target location.

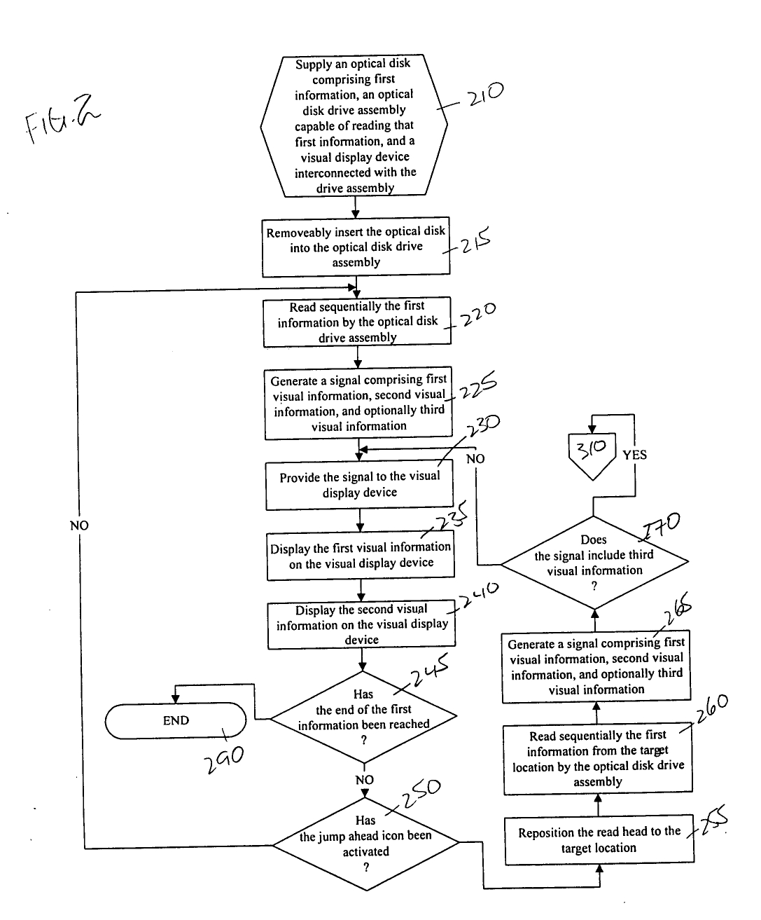

FIG. 2 summarizes the steps of Applicant's method to display visual information. Referring now to FIG. 2, in step 210 Applicant's method supplies an optical disk comprising encoded information, an optical disk drive assembly capable of reading the encoded information, and a visual display device interconnected with the optical disk drive assembly.

In step 215, Applicant's method removeably inserts the optical disk into the optical disk drive assembly In step 220, Applicant's method sequentially reads the encoded information by the optical disk drive assembly from the optical disk In step 225, Applicant's method generates a signal by the optical disk drive assembly using the encoded information, where that signal comprises first visual information and second visual information, where that first visual information comprises an entertainment event, and where that second visual information comprises the jump forward icon described above.

In step 230, Applicant's method provides the signal of step 225 to the visual display device. In step 235, Applicant's method displays the first visual information. In certain embodiments, the first information comprising the entertainment event further comprises an audio portion. In step 240, Applicant's method displays the second visual information. Steps 235 and 240 are performed synchronously.

In step 245, Applicant's method determines if the end of the encoded information has been reached, i.e. if the entertainment event has ended. In certain embodiments, step 240 further includes reading an end of file indicator by the optical disk drive assembly. In other embodiments, step 245 further includes determining by the optical disk drive assembly that the encoded information being read no longer comprises the first visual information. In still other embodiments, step 245 further includes determining by the optical display device that the signal provided no longer comprises the first visual information.

If Applicant's method determines in step 245 that the end of the encoded information has been reached, then the method transitions from step 245 to step 290 and ends. Alternatively, if Applicant's method determines in step 245 that the end of the encoded information has not been reached, then the method transitions from step 245 to step 250 wherein the method determines if the jump ahead icon has been activated.

If Applicant's method determines in step 250 that the jump ahead icon has not been activated, then the method transitions from step 250 to step 220 and continues as described herein. Alternatively, if Applicant's method determines in step 250 that the jump ahead icon has been activated, then the method transitions from step 250 to step 255 wherein the method rapidly repositions the read head portion of the optical disk drive assembly to a pre-determined target location.

In step 260, Applicant's method reads sequentially the encoded information beginning at the target location. In step 265, Applicant's method generates a signal from the encoded information, where that signal comprises the first visual information, and the second visual information, and optionally third visual information.

In certain embodiments, Applicant's third visual information comprises an animation format. By “animation format,” Applicant means a plurality of images depicting one or more cartoon-like objects in motion. In certain embodiments, Applicant's animation format comprises a male and a female engaging in sexual intercourse. In certain embodiments, Applicant's animation format comprises a human male and a human female engaging in sexual intercourse. In certain embodiments, Applicant's animation format an ejaculating penis.

In step 270, Applicant's method determines if the signal of step 265 comprises third visual information. If Applicant's method determines in step 270 that the signal of step 265 does not comprises third visual information then the method transitions from step 270 to step 230 and continues as described herein. If Applicant's method determines in step 270 that the signal of step 265 comprises third visual information that the method transitions from step 270 to step 310.

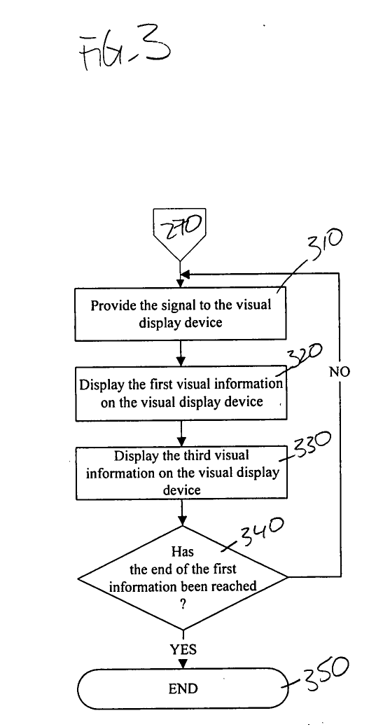

Referring now to FIG. 3, in step 310 Applicant's method provides the signal of step 265 to the display device. In step 320, Applicant's method displays target first visual information, i.e. the target portion of the entertainment event, on the display device. In step 330, Applicant's method displays the third visual information on the visual display device. Steps 320 and 330 are performed synchronously.

In step 340, Applicant's method determines if the end of the encoded information has been reached, i.e. if the entertainment event has ended. In certain embodiments, step 340 further includes reading an end of file indicator by the optical disk drive assembly. In other embodiments, step 340 further includes determining by the optical disk drive assembly that the encoded information being read no longer comprises the first visual information. In still other embodiments, step 340 further includes determining by the optical display device that the signal provided no longer comprises the first visual information.

If Applicant's method determines in step 340 that the end of the encoded information has been reached, then the method transitions from step 340 to step 350 and ends. Alternatively, if Applicant's method determines in step 340 that the end of the encoded information has not been reached, then the method transitions from step 340 to step 310 wherein the method continues as described herein.

In certain embodiments, Applicants' invention includes instructions residing in the optical disk drive assembly, where those instructions are executed by the optical disk assembly to performs steps 220, 225, 230, 245, 250, 255, 260, 265, and 270, recited in FIG. 2, and/or steps 310, 320, 330, and/or 340, recited in FIG. 3.

In other embodiments, Applicants' invention includes instructions residing in any other computer program product, where those instructions are executed by a computer external to, or internal to, the optical disk drive assembly, to perform steps 220, 225, 230, 245, 250, 255, 260, 265, and 270, recited in FIG. 2, and/or steps 310, 320, 330, and/or 340, recited in FIG. 3. In either case, the instructions may be encoded in an information storage medium comprising, for example, a magnetic information storage medium, an optical information storage medium, an electronic information storage medium, and the like. By “electronic storage media,” Applicants mean, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

1. A method to display visual information, comprising the steps of:
providing an optical disk comprising encoded information;
providing an optical disk drive assembly capable of reading said encoded information;
providing a visual display device interconnected with said optical disk drive assembly;
removeably inserting said optical disk into said optical disk drive assembly;
reading said encoded information by said optical disk drive assembly from said optical disk;
generating a signal by said optical disk drive assembly using said encoded information, wherein said signal comprises first visual information comprising an entertainment event and second visual information comprising a jump forward icon;
providing said signal to said visual display device;
displaying said entertainment event on said visual display device; and
continuously displaying said a jump forward icon on said visual display device.

2. The method of claim 1, wherein said optical disk drive assembly comprises a read head, and wherein said encoded information comprises target information beginning at a target location on said optical disk, further comprising the steps of:
activating said jump forward icon while said optical disk drive assembly is reading said encoded information from a first location on said optical disk using said read head;
repositioning said read head from said first location to said target location;
reading said target information beginning at said target location.

3. The method of claim 2, wherein said target location is determined by the optical disk manufacturer.

4. The method of claim 2, further comprising the steps of:
positioning said read head at a location selected by the optical disk drive assembly user;
defining said selected location as said target location.

5. The method of claim 2, wherein said displaying second information step further comprises continuously displaying said jump forward icon as long as said entertainment event is displayed.

6. The method of claim 5, wherein:
said providing a visual display device step further comprises providing a visual display device comprising (N) square inches of display area;
said displaying said entertainment event step further comprises displaying said entertainment event on said (N) square inches of display area; and
said displaying said jump forward icon as long as said entertainment event is displayed step further comprises continuously displaying said jump forward icon on about (N)/10 square inches of display area.

7. The method of claim 2, wherein generating a signal step further comprises generating a signal comprising first visual information, second visual information, and third information, wherein said third information comprises an animation format.

8. The method of claim 7, wherein said animation format comprises a plurality of images depicting a male and a female having sexual intercourse.

9. The method of claim 7, wherein said animation format comprises a plurality of images depicting an ejaculating penis.

10. An article of manufacture comprising a computer useable medium having computer readable program code disposed therein to display visual information on an interconnected visual display device, the computer readable program code comprising a series of computer readable program steps to effect:
receiving an optical disk comprising encoded information;
reading said encoded information from said optical disk;
generating a signal comprising first visual information and second visual information;
providing said signal to said interconnected visual display device;
wherein said first visual information comprises an entertainment event; and
wherein said second visual information comprises a jump forward icon.

11. The article of manufacture of claim 10, further comprising a read head, wherein said encoded information comprises target information beginning at a target location on said optical disk, further comprising the steps of:
determining if said jump forward icon has been activated;
operative if said jump forward icon has been activated, repositioning said read head to said target location;
reading said target information beginning at said target location.

12. The article of manufacture of claim 2, wherein said target information is predetermined by the manufacturer of said optical disk.

13. The article of manufacture of claim 11, wherein said computer readable program code further comprises a series of computer readable program steps to effect:
positioning said read head at a selected location determined by the user of the article of manufacture;
defining said selected location as said target location.

14. The article of manufacture of claim 11, wherein said computer readable program code further comprises a series of computer readable program steps to effect continuously displaying said jump forward icon while said entertainment event is displayed.

15. The article of manufacture of claim 14, wherein said visual display device comprises (N) square inches of display area, wherein said computer readable program code further comprises a series of computer readable program steps to effect continuously displaying said jump forward icon on about (N)/10 square inches of display area.

16. The article of manufacture of claim 11, wherein said computer readable program code further comprises a series of computer readable program steps to effect generating a signal using said encoded information, wherein said signal comprises first visual information, second visual information, and third information, wherein said third information comprises an animation format.

17. The article of manufacture of claim 16, wherein said animation format comprises a plurality of images depicting a male and a female having sexual intercourse.

18. The article of manufacture of claim 16, wherein said animation format comprises a plurality of images depicting an ejaculating penis.
